(19) United States
(12) Patent Application Publication
(10) Pub. No.: US 2026/0214334 A1
(43) Pub. Date: Jul. 23, 2026

(54) SHAFT SENSOR SHIFT MECHANISM FOR OPTICAL IMAGE STABILIZATION

(71) Applicant: Google LLC, Mountain View, CA (US)

(72) Inventors: Dansik Yoo, Sunnyvale, CA (US); Calvin Kyaw Wong, Cupertino, CA (US); Hyuk Jae Choi, Pleasanton, CA (US)

(21) Appl. No.: 19/028,685

(22) Filed: Jan. 17, 2025

(51) Int. Cl. H04N 23/68; H04N 23/54; H04N 23/67

(52) U.S. Cl. CPC H04N 23/687; H04N 23/54; H04N 23/675; H04N 23/6812

(57) ABSTRACT

An example device includes a first lens; a first prism optically after the first lens; a second prism; a second lens optically between the first prism and the second prism; an image sensor optically after the second prism; a camera housing comprising a first plurality of slots; a first carrier comprising: a first plurality of shafts configured to translate within the first plurality of slots of the camera housing along a first axis; a second plurality of slots; and a second carrier comprising a second plurality of shafts configured to translate within the second plurality of slots along a second axis that is perpendicular to the first axis, wherein the image sensor is attached to and carried by the second carrier.

### BACKGROUND

Mobile computing devices may include cameras to produce photos and videos. In some examples, movement of the camera while capturing a photo or video may result in a photo or video with undesirable effects (e.g., blur). To reduce the undesirable effects mobile computing devices may include sensor shift image stabilization.

### SUMMARY

In general, aspects of this disclosure are directed to a mobile computing device camera with a folded lens and a shaft mechanism for sensor shift image stabilization. Cameras of mobile computing devices may produce a photo or video by focusing light from the camera lens onto an image sensor. In some examples, to reduce thickness while maintaining the desired effective focal length (EFL), light may be folded (e.g., bent, turned, etc.) via one or more reflective or refractive elements (e.g., a prism) before being focused onto the image sensor. In one example, the mobile computing device may move (e.g., due to being held in unsteady hands, on a moving vehicle, etc.) while the camera is capturing a photo or video. The movement of the camera may cause undesirable effects to the photo or video (e.g., blur). To counteract the movement of the camera and prevent the undesirable effects, the mobile computing device may perform optical image stabilization (OIS). In some examples, a mobile computing device camera may generally include a mechanism that shifts the image sensor to perform OIS. For instance, a sensor shift mechanism may move the image sensor opposite movement of the computing device, thereby canceling out said movement and stabilizing the image sensor.

Sensor shift mechanisms may utilize one or more suspension wires and actuators to facilitate the movement of the image sensor along an X-axis and a Y-axis. Such designs may assist in providing image and video stabilization by shifting the image sensor. However, such designs may present one or more disadvantages. As one example, such designs may result in undesirable thickness of the sensor shift mechanism. As another example, due to certain level of spring constant, such designs when incorporated with a long EFL may not be able to shift the image sensor the necessary amount or direction. As another example, such designs may introduce undesired movements (e.g., tilt) of the image sensor.

In accordance with one or more aspects of this disclosure, a mobile computing device camera may include a folded lens and a shaft mechanism for sensor shift image stabilization. The shaft mechanism may include two laterally stacked carriers for sensor shift image stabilization. In one example, the first carrier may be referred to as an X carrier that facilitates movement of the image sensor in an X direction via a first plurality of shafts (herein, “X shafts”). In another example, the second carrier may be referred to as a Y carrier that facilitates movement of the image sensor in the Y direction via a second plurality of shafts (herein, “Y shafts”). The X and Y carriers may be laterally stacked in the X/Y direction, rather than vertically stacked in the Z direction. The Y carrier may carry the image sensor and be connected to the X carrier via the Y shafts and the X carrier may be connected to a camera housing via the X shafts. In this way, aspects of this disclosure may be able to shift the image sensor the necessary amount and direction while also reducing undesired movements of the image sensor and thickness of the sensor shift mechanism in the Z direction.

In one example, a device includes: a first lens; a first prism optically after the first lens; a second prism; a second lens optically between the first prism and the second prism; an image sensor optically after the second prism; a camera housing comprising a first plurality of slots; a first carrier comprising: a first plurality of shafts configured to translate within the first plurality of slots of the camera housing along a first axis; a second plurality of slots; and a second carrier comprising a second plurality of shafts configured to translate within the second plurality of slots along a second axis that is perpendicular to the first axis, wherein the image sensor is attached to and carried by the second carrier.

In another example, a method of assembling a device includes: aligning, a second plurality of shafts of a second carrier with a second plurality of insert slots of a first carrier, wherein an image sensor is attached to and carried by the second carrier; inserting, the second plurality shafts into the second plurality of insert slots, wherein the second plurality of insert slots correspond to a second plurality of slots of the first carrier that are substantially perpendicular to the second plurality of insert slots; integrating, the first carrier and the second carrier by sliding the second plurality of shafts within the second plurality of slots; aligning, a first plurality of shafts of the first carrier with a first plurality of insert slots of a camera housing; inserting, the first plurality of shafts into the first plurality of insert slots, wherein the first plurality of insert slots correspond to a first plurality of slots of the camera housing that are substantially perpendicular to the first plurality of insert slots; and integrating, the first carrier and the camera housing by sliding the first carrier within the first plurality of slots of the camera housing.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIGS. 1A-1D are conceptual diagrams illustrating a shaft mechanism for sensor shift image stabilization with two laterally stacked carriers, in accordance with one or more aspects of this disclosure.

FIG. 2 is a conceptual diagram illustrating the shaft mechanism for sensor shift image stabilization in further detail, in accordance with one or more aspects of this disclosure.

FIGS. 3A-3C are conceptual diagrams illustrating an example mobile computing device, in accordance with one or more aspects of this disclosure.

FIG. 4 is a flowchart illustrating an example mode of operation of an example camera that performs optical image stabilization, in accordance with one or more aspects of this disclosure.

### DETAILED DESCRIPTION

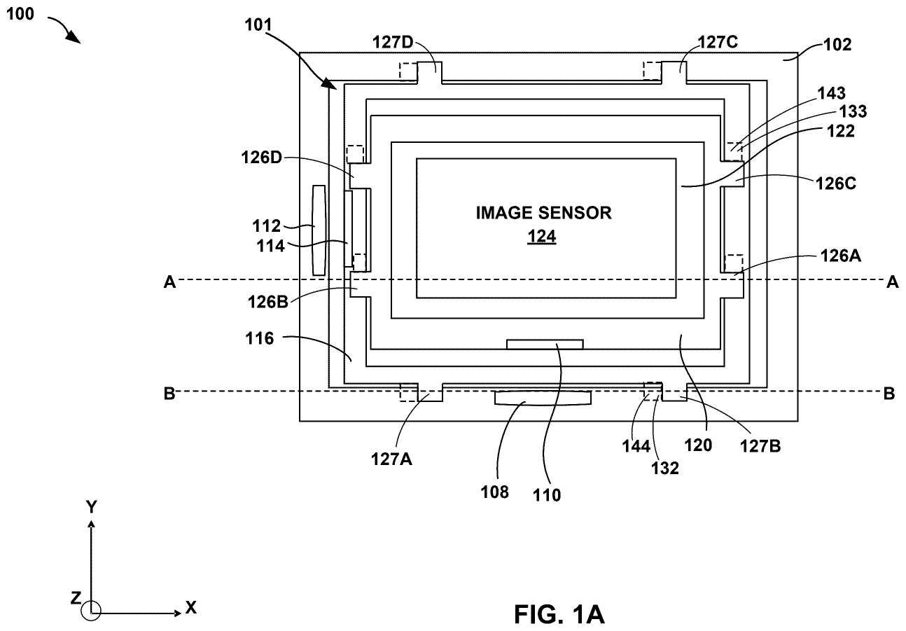

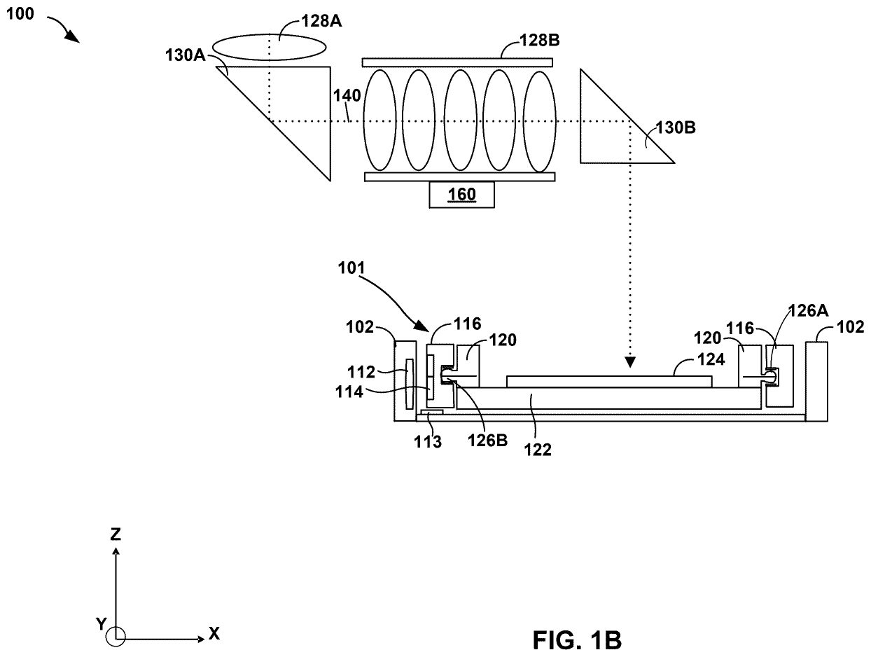

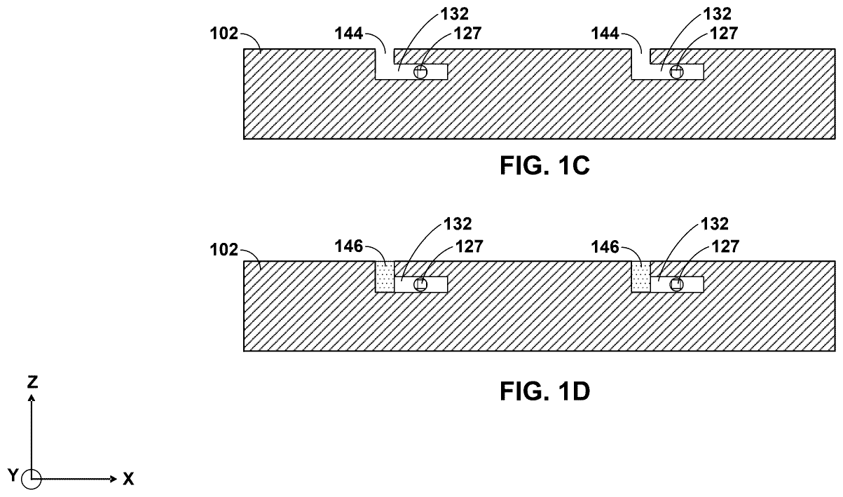

FIGS. 1A-1C are conceptual diagrams illustrating camera 100 that includes a shaft mechanism 101 for sensor shift image stabilization with two laterally stacked carriers (116 and 120), in accordance with one or more aspects of this disclosure. Camera 100 may be included in any mobile computing device that includes a camera such as a smartphone, a foldable smartphone, a tablet, a gaming system, etc. Camera 100 may be referred to as a camera module or camera assembly.

FIG. 1A shows a top view of camera 100 looking down at the X-Y plane, FIG. 1B shows a cross-sectional view of camera 100 on the X-Z plane (e.g., along line A-A) and is illustrated with additional components, and FIGS. 1C and 1D each show a cross-sectional view of camera 100 on the X-Z plane (e.g., along line B-B).

As shown in FIGS. 1A, 1B, 1C, and 1D camera 100 may include camera housing 102 and shaft mechanism 101 (herein referred to as, “mechanism 101”). Camera housing 102 may include printed circuit board (PCB) 122, and image sensor 124. As also shown, mechanism 101 may include X carrier 116, Y carrier 120, X shafts 127A, 127B, 127C, and 127D (collectively, “X shafts 127”), and Y shafts 126A, 126B, 126C, and 126D (collectively, “Y shafts 126”).

PCB 122 may be a circuit component on which image sensor 124 may be mounted. PCB 122 may include components that support operation of image sensor 124, such as integrated circuits (ICs), registers, multilayer ceramic capacitors (MLCCs), circuit components, and the like. In some examples, PCB 122 may include flexible electrical connections (e.g., PCB 122 may include slits or low stiffness wire structure).

A camera lens may capture light from a scene (e.g., mountains, people, food, etc.) to produce a photo or video of the scene. In some examples, the camera may include a folded telephoto design where one or more lenses and one or more reflective and/or refractive elements (e.g. a prism) fold/bend the captured light to produce the photo or video of the scene. For instance, a first camera lens may capture and focus the light onto a first prism which may fold/bend the light at, for example, a 90 degree angle to direct the light to a second lens that focuses the light onto a second prism. The second prism may then fold/bend the light at, for example, a 90 degree angle to direct the light onto image sensor 124. In this way, a desired effective focal length (EFL) may be achieved while maintaining or reducing the thickness of the camera.

Image sensor 124 may include photosensitive cells (e.g., photodiodes) that may react to light, e.g., convert light into electrical signals. In some examples, image sensor 124 may be a Charge-Coupled Device (CCD) sensor, a Complementary Metal-Oxide-Semiconductor (CMOS) sensor, a Bayer Filter Array Sensor, etc. In some examples, PCB 122 may include other components such as an analog-to-digital converter (ADC), which may convert the electrical signals from image sensor 124 into digital data that represents the scene. One or more processors may be included in the mobile computing device to process the digital data and produce the final photo or video of the scene. Further, in some examples, PCB 122 may include a gyroscope, accelerometer, and/or other components to provide comprehensive motion data of the camera. In other examples, one or more of the components to provide comprehensive motion data of the camera are included outside of PCB 122 (e.g., on a main PCB of the mobile computing device located near one or more processors.).

In general, mechanism 101 may perform operations to perform optical image stabilization (OIS). For instance, mechanism 101 may move (i.e., shift) a position of image sensor 124 to compensate for movement of camera 100 relative to a scene being captured via camera 100. As discussed above, mechanism 101 may include Y carrier 120, X carrier 116, X shafts 127, and Y shafts 126.

In the example illustrated by FIG. 1A, Y carrier 120 includes four sides. In other examples, Y carrier 120 may include more or less than four sides. In one example, a side may be considered a line segment or boundary that contributes to the overall structure of a mechanism. In the example illustrated by FIG. 1A, the sides of Y carrier 120 that are parallel to each other may be substantially similar in length. In the example illustrated by FIG. 1A, Y carrier 120 may resemble the shape of a rectangle or a square. In another example (not illustrated by FIG. 1A), each side of Y carrier 120 may not be similar in length. Y carrier 120 may generally include sides that are shorter in length than the sides of X carrier 116. In one example, X carrier 116 may be responsible for carrying Y carrier 120 (and thus image sensor 124) in the X direction. For instance, X carrier 116 may carry Y carrier 120 to the right in the X direction.

In one example, Y carrier 120 may be responsible for carrying PCB 122 (and thus image sensor 124) in the Y direction. For instance, Y carrier 120 may carry image sensor 124 upwards in the Y direction. In some examples, PCB 122 may be attached to Y carrier 120 via an adhesive (e.g., an epoxy adhesive, a silicon adhesive, an acrylic adhesive, double sided tape, etc.) and/or via mechanical components (e.g., screws, mounting clips, etc.).

In the example illustrated by FIG. 1A, X carrier 116 includes four sides. In other examples, X carrier 116 may include more or less than four sides. In the example illustrated by FIG. 1A, the sides of X carrier 116 that are parallel to each other (e.g., the two sides across from each other) may be substantially similar in length. In the example illustrated by FIG. 1A, X carrier 116 may be generally rectangular. In another example (not illustrated by FIG. 1A), each side of X carrier 116 may not be similar in length. X carrier 116 may generally include sides that are longer in length than the sides of Y carrier 120.

Camera housing 102 may resemble Y carrier 120 and/or X carrier 116. For instance, housing 102 may have four sides and, in the example of FIG. 1A, be substantially rectangular. Like Y carrier 120 and X carrier 116, camera housing 102 is not limited to the shape or number of sides illustrated by FIG. 1A. However, unlike Y carrier 120 and X carrier 116, camera housing 102 may not be considered part of mechanism 101. Such that camera housing 102, does not move (e.g., carry) to facilitate OIS. Rather, camera housing 102 may provide protection and support for camera 100.

While camera housing 102 may not be included in mechanism 101, in some examples, housing 102 may be connected to X carrier 116 via X shafts 127, which are included in mechanism 101. In the example illustrated by FIG. 1A, four X shafts 127 connect housing 102 to X carrier 116 and vice versa. For instance, two X shafts 127 are located next to each of the parallel sides of X carrier 116 that are oriented parallel to the X axis. In some examples, two X shafts 127 may be located next to each of the parallel sides of X carrier 116 that are oriented perpendicular to the X axis. In one example, X shafts 127 may facilitate movement of X carrier 116 in the X direction. For instance, X shafts may translate right or left along the X axis.

In some examples, X carrier 116 may be connected to Y carrier 120 and vice versa via Y shafts 126. In the example illustrated by FIG. 1A, X carrier 116 is connected to Y carrier 120 via four Y shafts 126. For instance, two Y shafts 126 are located next to each of the parallel sides of Y carrier 120 that are oriented parallel to the Y axis. In other examples, two Y shafts 126 may be located next to each of the parallel sides of Y carrier 120 that are oriented perpendicular to the Y axis. In one example, Y shafts 126 may facilitate movement of Y carrier 120 in the Y direction. For instance, Y shafts 126 may translate up or down along the Y axis.

In one example, housing 102 may include X slots 132. X shafts 127 may translate within X slots 132. X slots 132 may serve as a boundary for movement of X carrier 116, such that X carrier 116 can only move (in the X directions) as far as X slots 132 allow X shafts 127 to translate.

In another example, X carrier 116 may include Y slots 133 that are substantially similar to X slots 132. Y shafts 126 may translate within Y slots 133. Y slots 133 may serve as a boundary for movement of Y carrier 120, such that Y carrier 120 can only move (in the Y direction) as far as Y slots 133 allow Y shafts 126 to translate.

In addition to X slots 132 and Y slots 133 facilitating movement of the carriers (X carrier 116 and Y carrier 120, respectively), X slots 132 and Y slots 133 may be further configured to facilitate integration between X carrier 116, Y carrier 120, and housing 102. For instance, X slots 132 and Y slots 133 may be designed such that a carrier may be put onto the slot and slid in for integration. In one example, X carrier 116 may be put onto housing 102, such that X shafts 127 are put on to X slots 132. X carrier 116 (specifically, X shafts 127) may then be slid into X slots 132 so that X carrier 116 is integrated with housing 102. In this way, X slots 132 and Y slots 133 may provide stabilization to X carrier 116 and Y carrier 120 within housing 102.

The slot to carrier arrangements and the arrangement of the shafts of FIGS. 1A-1D are merely one possible arrangement. For instance, in another example, X carrier 116 may include X slots 132.

Mechanism 101 may include one or more actuators that move X carrier 116 and/or Y carrier 120. For instance, mechanism 101 may include a first actuator that moves X carrier 116 along the X direction, and a second actuator that moves Y carrier 120 along the Y direction. These actuators may include any suitable electromechanical components, such as voice coil motors (VCMs), motors, and the like. As shown in FIGS. 1A and 1B, mechanism 101 may include X coil 112, Y coil 108, X magnet 114, and Y magnet 110. Each coil of mechanism 101 may correspond to (e.g., be located close to) a magnet of mechanism 101. For instance, X coil 112 may correspond to X magnet 114 and Y coil 108 may correspond to Y magnet 110.

In one example, a coil from mechanism 101 may be an electric conductor (e.g., a wire) in a spiral shape that uses an electric current to generate a magnetic field. Such that, a coil from mechanism 101 may generate an attraction or repulsion relationship with a magnet from mechanism 101.

Each coil of mechanism 101 may be responsible for moving image sensor 124 in an X or Y direction. For instance, X coil 112 may be responsible for shifting image sensor 124 in an X direction via X magnet 114 and Y coil 108 may be responsible for shifting image sensor 124 in a Y direction via Y magnet 110. The coil and magnet pairs may collectively be considered actuators and may operate to perform OIS. For instance, X coil 112 and X magnet 114 may be considered a first actuator or an X actuator and Y coil 108 and Y magnet 110 may be considered a second actuator or a Y actuator. In some examples, the X actuator and/or the Y actuator may each include a yoke. The yoke may be any mechanical component that ensures proper alignment and/or motion transmission.

In some examples, motion data may be associated with an electric signal that is provided to one or more coils of mechanism 101. The electric signal may be used to direct movement of image sensor 124. For instance, camera 100 may move along the X axis (e.g., left or right) while capturing a photo. One or more gyroscopes, accelerometers, and/or other components of the mobile computing device may collect motion data of camera 100. One or more processors may generate a signal, based on the motion data, and provide the signal to an X actuator (e.g., that includes X coil 112 and X magnet 114). Receipt of the signal may cause the X actuator to move X carrier 116 (which includes image sensor 124) in the necessary direction (along the X axis) to counteract the movement of camera 100 (e.g., in response to receiving the signal, X coil 112 may generate a magnetic field that interacts with X magnet 114 to move X carrier 116).

In one example, one or more processors of a mobile computing device that includes camera 100 may cause X carrier 116 to move, via X coil 112 and X magnet 114, in an X direction to perform OIS. In another example, one or more processors of a mobile computing device that includes camera 100 may cause Y carrier 120 to move, via Y coil 108 and Y magnet 110, in a Y direction to perform OIS.

In accordance with one or more aspects of this disclosure, camera 100 of a mobile computing device may include a folded lens (e.g., a periscope lens) and mechanism 101 for sensor shift image stabilization with X carrier 116 laterally stacked with Y carrier 120. Image sensor 124 may be attached to Y carrier 120. In one example, Y carrier 120 may move image sensor 124 in the Y direction within X carrier 116 via Y shafts 126. In another example, X carrier 116 may move in the X direction within housing 102 via X shafts 127. In some examples, because Y carrier 120 is laterally stacked within X carrier 116 and attached to X carrier 116 via X shafts 127, when X carrier 116 moves in the X direction image sensor 124 moves in the X direction as well. Each carrier may include designated shafts, magnets, and coils that facilitate movement in the carrier's respective direction, such that the image sensor may be shifted the necessary amount to perform OIS. In this way, aspects of this disclosure may reduce undesired movements of the image sensor while also reducing thickness of mechanism 101 for sensor shift image stabilization.

FIG. 1B shows a cross-sectional view of camera 100 on the X-Z plane (e.g., along line A-A) and is illustrated with additional components. In the example shown, camera 100 includes first prism 130A and second prism 130B (collectively, “prisms 130”), first lens 128A and second lens 128B (collectively, “lenses 128”), housing 102, and mechanism 101.

Prisms 130 and lenses 128 may be arranged along optical axis 140. Optical axis 140 may be an axis of symmetry of camera 100 and may represent the ideal path for light to travel. In some examples, aberrations or distortions may occur as a result of light deviating from optical axis 140. Prisms 130 may each be configured to fold the light captured by camera 100 by effectively redirecting optical axis 140 in a different physical direction, e.g., redirect light via reflection without substantial optical power. In some examples, optical axis 140 may be defined by lenses 128, and in other examples, optical axis 140 may be defined by another element of camera 100.

In the example shown, lens 128A may be positioned optically before prism 130A, which may be positioned optically before lens 128B, which may be positioned optically before prism 130B, which may be positioned optically before mechanism 101. In one example, actuator 160 may be positioned near lens 128B. In some examples, prism 130A and prism 130B may be separated from each other by at least the physical length of lens 128B.

In the example shown, prism 130B is placed at ninety degrees with respect to prism 130A. Prisms 130 may fold optical axis 140 to any direction in a plane substantially perpendicular to the direction of the optical axis entering prisms 130. For example, prism 130B may fold optical axis 140 such that it is perpendicular to the X axis.

Prisms 130 may be front surface reflecting prisms. For example, a first surface of each of prisms 130 reflects light such that substantially no light enters prisms 130. In other examples, prisms 130 may be refracting prisms in which light enters each of prisms 130 and reflects off an inner surface of one or both of prisms 130, e.g., via total internal reflection (TIR). In some examples, each of prisms 130 may be a different type of prism (e.g., prism 130A may be a front surface reflecting prism and prism 130B may be a refracting prism).

Prisms 130 and lenses 128 may be made of glass, plastic, or any suitable material. For example, prisms 130 and lenses 128 may be comprised of plastic material, such as a polycarbonate, a polyester, a polystyrene, an acrylic such as poly(methyl methacrylate) (PMMA), or any suitable polymer, an injection molded plastic material, or other transparent materials (e.g., glass), and may include one or more coatings (e.g., highly reflective coatings for prisms 130 and anti-reflection coatings for lenses 128). In some examples, lens 128B may be an autofocus lens (e.g., lens 128B may be designed to move for autofocus functionality). In one example, actuator 160 may move lens 128B to perform autofocus.

As illustrated in FIG. 1B, mechanism 101 may include an X actuator (e.g., X coil 112, X magnet 114, and X yoke 113), housing 102, X carrier 116, Y carrier 120, Y shafts 126, PCB 122, and image sensor 124. In some examples, light may enter camera 100, via lens 128A, and follow folded optical axis 140 to be focused onto image sensor 124. Optical axis 140 may be folded via prisms 130 to reduce thickness while maintaining the desired EFL. In some examples, camera 100 may move (e.g., due to being held in unsteady hands, on a moving vehicle, etc.) while the camera is capturing light. In some examples, movement of the camera may cause undesirable effects to the photo or video (e.g., blur). In accordance with one or more aspects of this disclosure, mechanism 101 may counteract the movement of camera 100 and prevent the undesirable effects by shifting image sensor 124 a necessary amount and direction via X carrier 116 and/or Y carrier 120. Where X carrier 116 and Y carrier 120 each include designated shafts, magnets, and coils that facilitate movement in the carrier's respective direction.

FIGS. 1C and 1D each show a cross-sectional view of camera 100 on the X-Z plane (e.g., along line B-B). X carrier 116 may be movably connected to (e.g., integrated with) housing 102. For instance, X shafts 127 of X carrier 116 may extend into, and slide within, slots 132 of housing 102. Slots 132 may extend along the X-axis (e.g., such that movement of X shafts 127 within slots 132 allows X carrier 116 to translate along the X-axis). While shown in FIGS. 1C and 1D as having elliptical cross-sections, X shafts 127 may be formed with any suitable shape to slide within slots 132. In some examples, X shafts 127 may include bearings at their ends (e.g., bearings that slide within slots 132). The bearings may be plain bearings, ball bearings, or any other type of bearing.

Slots 132 may include slot openings 144. During assembly, X carrier 116 may be attached to housing 102 by placing X shafts 127 into slots 132 via slot openings 144. As illustrated by FIG. 1D, stoppers 146 may be inserted into slot openings 144 to retain X shafts 127 within slots 132.

While FIGS. 1C and 1D illustrate an example integration of X carrier 116 and housing 102, this disclosure is not so limited. For instance, as illustrated by FIG. 1A, X carrier 116 may include slot openings 143 such that, Y carrier 120 may be integrated with X carrier 116 by placing Y shafts 126 into slot openings 143. Further, stoppers (e.g., stoppers 146) may be inserted into slot openings 143 to retain Y shafts 126 within their respective slots (e.g., slots 132). Integration of Y carrier 120 and X carrier 116 may be substantially similar to the integration of X carrier 116 and housing 102 (illustrated by FIGS. 1C and 1D). In this way, Y carrier 120, X carrier 116, and housing 102 may all be connected.

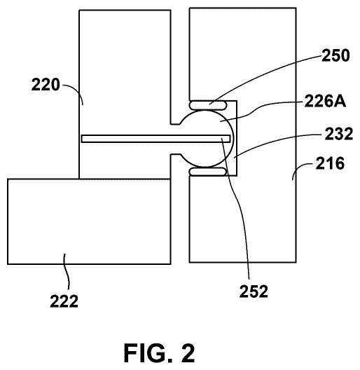

FIG. 2 is a conceptual diagram illustrating the shaft mechanism for sensor shift image stabilization in further detail, in accordance with one or more aspects of this disclosure. FIG. 2 includes X carrier 216, Y carrier 220, PCB 222, Y shaft 226A, insert mold 252, slot 232, and grease 250. X carrier 216, Y carrier 220, PCB 222, slot 232, and Y shaft 226A may be examples of X carrier 116, Y carrier 120, PCB 122, slot 132, and Y shaft 126A of FIG. 1.

Y shaft 226A may be merged (e.g., monolithic with, combined, joined, unified, fused, etc.) with Y carrier 220. Such that Y shaft 226A may be considered part of Y carrier 220. In this way, the load (e.g., forces) acting on Y shaft 226A may be distributed across Y carrier 220 and movement between Y carrier 220 and Y shaft 226A may be prevented. Further, Y shaft 226A may include insert mold 252 for increased strength within Y shaft 226A. In one example, insert mold 252 may extend from Y shaft 226A into Y carrier 220 for additional increased mechanical strength. In some examples, insert mold 252 may be made of a stronger material than the shafts (e.g., insert mold 252 may be made of metal while shaft 226A is made of plastic). Insert mold 252 may be inserted into a mold used to form at least Y shaft 226A during molding of Y shaft 226A. As such, a material of Y shaft 226A may completely surround insert mold 252 while insert mold 252 provides increased strength (e.g., reducing a likelihood that Y shaft 226A breaks off or otherwise departs from Y carrier 220).

Y shaft 226A may be formed with any suitable shape to slide within slot 232. In some examples, Y shaft 226A may include a cylindrical shaft with a bearing at the end (e.g., a bearing that slides within slot 232). The bearing may be a plain bearing, a ball bearing, or any other type of bearing. In some examples, a round bearing may be utilized to facilitate smooth movement within slot 232. In the example illustrated by FIG. 2, Y shaft 226A includes a round bearing.

Slot 232 may include any type of lubricant (e.g., grease). In some examples, the lubricant may be applied to reduce friction, wear, and/or heat generation, while also facilitating smooth movement of mechanism 101. In some examples, slot 232 and/or Y shaft 226A may include lubricant retention geometry (e.g., chamfers) to hold lubricant in place. Aspects of this disclosure are discussed with respect to the components illustrated in FIG. 2 to facilitate an ease of understanding. This is not intended to limit the scope of the disclosure to the components illustrated in FIG. 2. For instance, Y shaft 226A may be any of X shafts 127 or Y shafts 126 of FIG. 1.

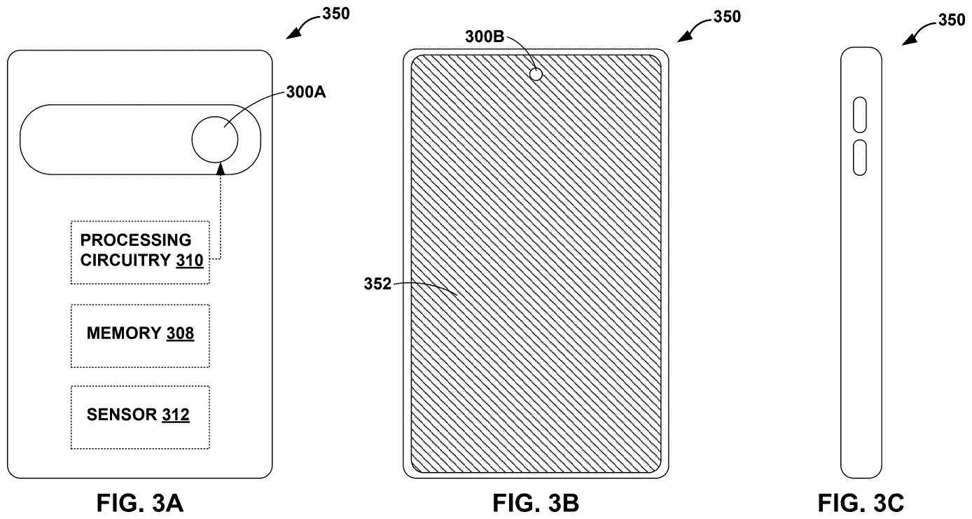

FIGS. 3A-3C are conceptual diagrams illustrating an example mobile computing device, in accordance with one or more aspects of this disclosure. As shown in FIGS. 3A-3C, mobile computing device 350 may include camera module 300A and/or camera module 300B (collectively, “camera modules 300”). FIG. 3A may be a back view of mobile computing device 350, FIG. 3B may be a front view of mobile computing device 350, and FIG. 3C may be a side view of mobile computing device 350.

As shown in FIG. 3A, camera module 300A may be a rear-facing camera located on a back of mobile computing device 350 that may include sensor 312 and processing circuitry 310 (e.g., one or more processors) coupled to a memory 308. In some examples, sensor 312 may be one or more of a gyroscope, accelerometer, and/or other components (e.g., an image sensor) to provide comprehensive motion data of camera modules 300. Memory 308 may be configured to store program instructions, motion data, and/or data accessible by processing circuitry 310. Memory 308 may be implemented using any suitable memory technology, such as static random access memory (SRAM), synchronous dynamic RAM (SDRAM), nonvolatile/flash-type memory, or any other type of memory. Program instructions may be configured to implement various interfaces, methods and/or data for controlling operations of one or more of camera modules 300 and for capturing and processing images with one or more of camera modules 300 or other methods or data, for example interfaces and methods for capturing, displaying, processing, and storing images captured with one or more of camera modules 300. In some examples, program instructions and/or data may be received, sent, or stored upon different types of computer-accessible media or on similar media separate from memory 308 or mobile computing device 350.

In some examples, memory 308 may include program instructions which may be processor-executable to implement any element or action to support camera modules 300, including but not limited to image processing software and interface software for controlling camera modules 300. In some examples, images captured by camera modules 300 may be stored to memory 308. In addition, metadata for images captured by camera modules 300 may be stored using memory 308.

In operation, processing circuitry 310 may control operation of camera 300A. For instance, processing circuitry 310 may output signals (e.g., in response to motion data collected by sensor 312) that controls operation of actuators of camera 300A (e.g., to perform OIS and/or AF).

As shown in FIG. 3B, camera module 300B may be a front facing camera located on a front of mobile computing device 350. For instance, camera module 300B may be a through-display or hole-punch camera located at display 352 of mobile computing device 350.

One or both of camera module 300A and/or 300B may be examples of camera module 100 of FIGS. 1A-1D. For instance, one or both of camera module 300A and/or 300B may include a mechanism that performs sensor shift optical image stabilization (e.g., similar to mechanism 101 of FIGS. 1A-1D).

In operation, mobile computing device 350 may move (e.g., due to being held in unsteady hands, on a moving vehicle, etc.) while one of camera modules 300A or 300B is capturing a photo or video. The movement of camera modules 300A or 300B may cause undesirable effects to the photo or video (e.g., blur). To counteract the movement of camera modules 300A or 300B and prevent the undesirable effects, the mechanism(s) of camera modules 300A or 300B may perform OIS, specifically sensor shift image stabilization (e.g., based on signals received from processing circuitry 310).

In accordance with one or more aspects of this disclosure, camera modules 300A or 300B may include a folded lens and mechanism(s) with two laterally stacked carriers for sensor shift image stabilization. In one example, the first carrier may be referred to as an X carrier (e.g., similar to X carrier 116 of FIGS. 1A-1D) that facilitates movement of an image sensor in an X direction via a first plurality of shafts (e.g., similar to X shafts 127 of FIGS. 1A-1D). In another example, the second carrier may be referred to as a Y carrier (e.g., similar to Y carrier 120 of FIGS. 1A-1D) that facilitates movement of an image sensor in the Y direction via Y shafts (e.g., similar to Y shafts 126 of FIGS. 1A-1D). The X and Y carriers may be laterally stacked in the X/Y direction, rather than vertically stacked in the Z direction. The Y carrier may carry the image sensor and be connected to the X carrier via the Y shafts and the X carrier may be connected to a camera housing (e.g., similar to camera housing 102 of FIGS. 1A-1D) via the X shafts. In this way, aspects of this disclosure may be able to shift the image sensor within the mechanism(s) of camera modules 300A or 300B the necessary amount and direction while also reducing undesired movements of the image sensor and thickness of camera modules 300A or 300B.

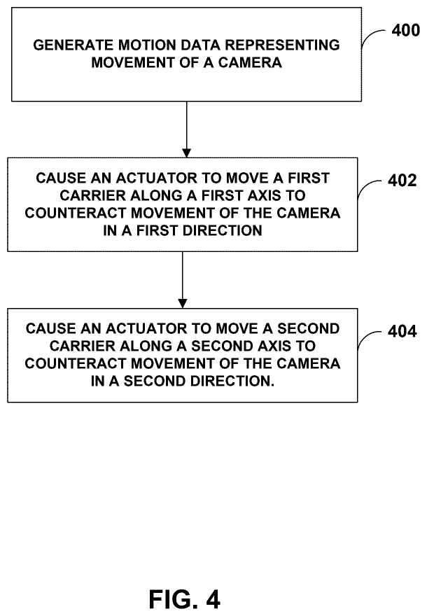

FIG. 4 is a flowchart illustrating an example mode of operation of an example camera that performs optical image stabilization, in accordance with one or more aspects of this disclosure. Although the example operation of FIG. 4 is described as being performed by camera 100 of FIGS. 1A-1D, in other examples some or all of the example operations may be performed by another camera.

Camera 100 may include a folded lens with two prisms (configured to fold an optical axis of camera 100) and two lenses (one of which may be configured to perform autofocus). Undesirable photo or video effects (e.g., blur) may occur because of the movement of camera 100. To prevent these effects, in response to the movement of camera 100, mechanism 101 may perform OIS. For instance, mechanism 101 may move (i.e., shift) a position of an image sensor (e.g., image sensor 124) to compensate for movement of camera 100 relative to the photo or video being captured via camera 100.

One or more components may generate motion data representing movement of camera 100 (400). For instance, one or more of a gyroscope, an accelerometer, or other sensors may generate motion data representing movement of camera 100 in a first direction (e.g., an X direction) and motion data representing movement of camera 100 in a second direction (e.g., a Y direction) while camera 100 is capturing a photo or video.

One or more processors of camera 100, or a host device, may process the motion data and control operation of actuators of camera 100 to perform OIS. As one example, the one or more processors may cause a first actuator to move a first carrier (e.g., first carrier 116) of camera 100 along a first axis to counteract movement of camera 100 in the first direction (402). Movement of the first carrier along the first axis may cause movement of a second carrier (e.g., second carrier 120) of camera 100 along the first axis. In one example, the first axis may be an X axis. For instance, responsive to the motion data representing movement of camera 100 in the first direction indicating that camera 100 is moving in a positive X direction, the one or more processors may output a signal that causes a first coil (e.g., first coil 112) to generate a magnetic field that interacts with a first magnet (e.g., first magnet 114) to move the first carrier in a negative X direction. In some examples, the first actuator may include the first coil attached to a camera housing (e.g., camera housing 102) and the first magnet attached to the first carrier.

As another example, the one or more processors may cause a second actuator to move a second carrier (e.g., second carrier 120) of camera 100 along a second axis to counteract movement of camera 100 in a second direction (404). In one example, the second axis may be a y axis. For instance, responsive to the motion data representing movement of camera 100 in the second direction indicating that camera 100 is moving in the negative Y direction, the one or more processors may output a signal that causes a second coil (e.g., second coil 108) to generate a magnetic field that interacts with a second magnet (e.g., second magnet 110) to move the second carrier in a positive Y direction. In some examples, the second actuator may comprise the second coil attached to the camera housing and the second magnet attached to the second carrier.

In one example, camera 100 may comprise a first plurality of shafts (e.g., first plurality of shafts 127) and a second plurality of shafts (e.g., second plurality of shafts 126) configured to facilitate movement of the first carrier and the second carrier, respectively. The first plurality of shafts may include four shafts, and each shaft may be merged with the first carrier. The second plurality of shafts may include four shafts, and each shaft may be merged with the second carrier. In some examples, each of the first and second plurality of shafts may comprise an insert mold and/or a round bearing. In one example, the first and second plurality of shafts may move within slots (e.g., slot 132) that include grease to facilitate smooth movement.

Aspects of this disclosure include the following examples.

Example 1. A device comprising: a first lens; a first prism optically after the first lens; a second prism; a second lens optically between the first prism and the second prism; an image sensor optically after the second prism; a camera housing comprising a first plurality of slots; a first carrier comprising: a first plurality of shafts configured to translate within the first plurality of slots of the camera housing along a first axis; a second plurality of slots; and a second carrier comprising a second plurality of shafts configured to translate within the second plurality of slots along a second axis that is perpendicular to the first axis, wherein the image sensor is attached to and carried by the second carrier.

Example 2. The device of example 1, wherein the first plurality of shafts are merged with the first carrier, and wherein the second plurality of shafts are merged with the second carrier.

Example 3. The device of example 1 or example 2, wherein one or both of the first plurality of slots and the second plurality of slots each comprise a stopper configured to: retain the first plurality of shafts within the first plurality of slots; and retain the second plurality of shafts within the second plurality of slots.

Example 4. The device of any of examples 1-3, further comprising an insert mold within one or both of the first plurality of shafts and the second plurality of shafts, wherein the insert mold strengthens one or both of the first plurality of shafts and the second plurality of shafts.

Example 5. The device of any of examples 1-4, wherein the first plurality of shafts and the second plurality of shafts each comprise a round bearing.

Example 6. The device of example 1, wherein the first prism and the second prism are each configured to fold an optical axis of the device.

Example 7. The device of example 1, further comprising: a first actuator configured to move the first carrier along the first axis; a second actuator configured to move the second carrier along the second axis; and one or more processors configured to: perform optical image stabilization (OIS), wherein to perform OIS, the one or more processors are configured to: cause, based on sensor data indicating movement of the device in a first direction, the first actuator to move the first carrier along the first axis; and cause, based on sensor data indicating movement of the device in a second direction, the second actuator to move the second carrier along the second axis.

Example 8. The device of example 7, wherein one or both of: the first actuator comprises: a first coil attached to the camera housing; and a first magnet attached to the first carrier; and the second actuator comprises: a second coil attached to the camera housing; and a second magnet attached to the second carrier.

Example 9. The device of any of examples 7-8, further comprising: a third actuator configured to move the second lens, wherein the one or more processors are further configured to cause the third actuator to move the second lens to perform autofocus.

Example 10. The device of example 1 or example 3, wherein each of the first plurality of slots and each of the second plurality of slots include grease.

Example 11. The device of example 1 or example 7, wherein the first axis is an X axis of the image sensor, and wherein the second axis is a Y axis of the image sensor.

Example 12. The device of any of examples 1-11, wherein movement of the first carrier along the first axis causes movement of the second carrier and the image sensor along the first axis.

Example 13. The device of any of examples 1-12, wherein the first plurality of shafts comprises four shafts, and wherein the second plurality of shafts comprises four shafts.

Example 14. A method of assembling a device comprising: aligning, a second plurality of shafts of a second carrier with a second plurality of insert slots of a first carrier, wherein an image sensor is attached to and carried by the second carrier; inserting, the second plurality shafts into the second plurality of insert slots, wherein the second plurality of insert slots correspond to a second plurality of slots of the first carrier that are substantially perpendicular to the second plurality of insert slots; integrating, the first carrier and the second carrier by sliding the second plurality of shafts within the second plurality of slots; aligning, a first plurality of shafts of the first carrier with a first plurality of insert slots of a camera housing; inserting, the first plurality of shafts into the first plurality of insert slots, wherein the first plurality of insert slots correspond to a first plurality of slots of the camera housing that are substantially perpendicular to the first plurality of insert slots; and integrating, the first carrier and the camera housing by sliding the first carrier within the first plurality of slots of the camera housing.

Example 15. The method of example 14, further comprising: inserting a stopper into one or both of the first plurality of insert slots and the second plurality of insert slots, wherein the stopper is configured to: retain the first plurality of shafts within the first plurality of slots; and retain the second plurality of shafts within the second plurality of slots.

Example 16. The method of example 14 or example 15, further comprising applying grease to one or both of the first plurality of slots and the second plurality of slots.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the aspects of this disclosure described herein. In addition, in some aspects, the functionality described herein may be provided within dedicated hardware and/or software modules. Also, the aspects of this disclosure could be fully implemented in one or more circuits or logic elements.

Aspects of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the aspects of this disclosure, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

1. A device comprising:
a first lens;
a first prism optically after the first lens;
a second prism;
a second lens optically between the first prism and the second prism;
an image sensor optically after the second prism;
a camera housing comprising a first plurality of slots;
a first carrier comprising:
a first plurality of shafts configured to translate within the first plurality of slots of the camera housing along a first axis;
a second plurality of slots; and
a second carrier comprising a second plurality of shafts configured to translate within the second plurality of slots along a second axis that is perpendicular to the first axis, wherein the image sensor is attached to and carried by the second carrier.

2. The device of claim 1, wherein the first plurality of shafts are merged with the first carrier, and wherein the second plurality of shafts are merged with the second carrier.

3. The device of claim 1, wherein one or both of the first plurality of slots and the second plurality of slots each comprise a stopper configured to:
retain the first plurality of shafts within the first plurality of slots; and
retain the second plurality of shafts within the second plurality of slots.

4. The device of claim 1, further comprising an insert mold within one or both of the first plurality of shafts and the second plurality of shafts, wherein the insert mold strengthens one or both of the first plurality of shafts and the second plurality of shafts.

5. The device of claim 1, wherein the first plurality of shafts and the second plurality of shafts each comprise a round bearing.

6. The device of claim 1, wherein the first prism and the second prism are each configured to fold an optical axis of the device.

7. The device of claim 1, further comprising:
a first actuator configured to move the first carrier along the first axis;
a second actuator configured to move the second carrier along the second axis; and
one or more processors configured to:
perform optical image stabilization (OIS), wherein to perform OIS, the one or more processors are configured to:
cause, based on sensor data indicating movement of the device in a first direction, the first actuator to move the first carrier along the first axis; and
cause, based on sensor data indicating movement of the device in a second direction, the second actuator to move the second carrier along the second axis.

8. The device of claim 7, wherein one or both of:
the first actuator comprises:
a first coil attached to the camera housing; and
a first magnet attached to the first carrier; and
the second actuator comprises:
a second coil attached to the camera housing; and
a second magnet attached to the second carrier.

9. The device of claim 7, further comprising:
a third actuator configured to move the second lens,
wherein the one or more processors are further configured to cause the third actuator to move the second lens to perform autofocus.

10. The device of claim 1, wherein each of the first plurality of slots and each of the second plurality of slots include grease.

11. The device of claim 1, wherein the first axis is an X axis of the image sensor, and wherein the second axis is a Y axis of the image sensor.

12. The device of claim 1, wherein movement of the first carrier along the first axis causes movement of the second carrier and the image sensor along the first axis.

13. The device of claim 1, wherein the first plurality of shafts comprises four shafts, and wherein the second plurality of shafts comprises four shafts.

14. A method of assembling a device comprising:
aligning, a second plurality of shafts of a second carrier with a second plurality of insert slots of a first carrier, wherein an image sensor is attached to and carried by the second carrier;
inserting, the second plurality shafts into the second plurality of insert slots, wherein the second plurality of insert slots correspond to a second plurality of slots of the first carrier that are substantially perpendicular to the second plurality of insert slots;
integrating, the first carrier and the second carrier by sliding the second plurality of shafts within the second plurality of slots;
aligning, a first plurality of shafts of the first carrier with a first plurality of insert slots of a camera housing;
inserting, the first plurality of shafts into the first plurality of insert slots, wherein the first plurality of insert slots correspond to a first plurality of slots of the camera housing that are substantially perpendicular to the first plurality of insert slots; and
integrating, the first carrier and the camera housing by sliding the first carrier within the first plurality of slots of the camera housing.

15. The method of claim 14, further comprising:
inserting a stopper into one or both of the first plurality of insert slots and the second plurality of insert slots, wherein the stopper is configured to:
retain the first plurality of shafts within the first plurality of slots; and
retain the second plurality of shafts within the second plurality of slots.

16. The method of claim 14, further comprising applying grease to one or both of the first plurality of slots and the second plurality of slots.
